(19) United States
(12) Patent Application Publication
(10) Pub. No.: US 2008/0137019 A1
(43) Pub. Date: Jun. 12, 2008

(54) LIQUID CRYSTAL DISPLAY DEVICE AND METHOD OF MANUFACTURE

(76) Inventors: Jeong-uk HEO, Seongnam-si (KR); Nam-seok Lee, Suwon-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/877,495

(22) Filed: Oct. 23, 2007

(30) Foreign Application Priority Data
Dec. 11, 2006 (KR) 10-2006-0125769

(51) Int. Cl. G02F 1/1343; G02F 1/13

(52) U.S. Cl. 349/143; 349/187

(57) ABSTRACT

A liquid crystal display device, includes: a first insulating substrate, a gate line and a data line which are formed on the first insulating layer insulatedly crossing each other to define a pixel region; a thin film transistor electrically connected with the gate line and the data line; a pixel electrode electrically connected with the thin film transistor, and comprises a stem electrode and a plurality of branch electrodes connected with the stem electrode and in parallel with each other; a second insulating substrate; a common electrode formed on the second insulating substrate; an organic layer formed on the common electrode having an opening exposing the common electrode in parallel with the branch electrodes; and a liquid crystal layer interposed between the first insulating substrate and the second insulating substrate.

### CROSS-REFERENCE TO RELATED APPLICATIONS

This application claims priority from Korean Patent Application No. 2006-0125769, filed on Dec. 11, 2006, in the Korean Intellectual Property Office, the disclosure of which is incorporated herein by reference.

### BACKGROUND OF THE INVENTION

1. Field of the Invention

Apparatuses and methods consistent with the present invention relate to a liquid crystal display device and a manufacturing method of the same, and more particularly, to a liquid crystal display device which includes a pixel electrode having a branch electrode.

2. Description of the Related Art

A liquid crystal display device includes a liquid crystal display panel. The liquid crystal display panel includes a first substrate having a thin film transistor, a second substrate facing the first substrate and a liquid crystal layer interposed between the first substrate and the second substrate. As the liquid crystal display panel does not emit light itself, a backlight unit may be provided behind the first substrate.

A pixel electrode is formed on the first substrate and a common electrode is formed on the second substrate. A liquid crystal layer is formed between the pixel electrode and the common electrode. An electric field which is formed between the pixel electrode and the common electrode determines an arrangement of the liquid crystal layer.

In some liquid crystal display devices, a pixel electrode and a common electrode are patterned to divide a pixel region into a plurality of sub pixel regions. The pixel electrode and the common electrode are patterned to be spaced from each other and surround the sub pixel regions. An electric field is created by voltage differences between the pixel electrode and the common electrode.

However, the liquid crystal display devices employing such a configuration require an additional process to pattern the common electrode, thereby causing a complicated manufacturing process.

### SUMMARY OF THE INVENTION

The foregoing and/or other aspects of the present invention can be achieved by providing a liquid crystal display device comprising: a first insulating substrate, a gate line and a data line formed on the first insulating layer insulatedly crossing each other to define a pixel region; a thin film transistor electrically connected with the gate line and the data line; a pixel electrode electrically connected with the thin film transistor, and comprises a stem electrode and a plurality of branch electrodes connected with the stem electrode and in parallel with each other; a second insulating substrate; a common electrode formed on the second insulating substrate; an organic layer formed on the common electrode having an opening exposing the common electrode in parallel with the branch electrodes; and a liquid crystal layer interposed between the first insulating substrate and the second insulating substrate.

According to an aspect of the invention, an interval between the branch electrodes is larger than a width of the branch electrodes.

According to an aspect of the invention, the common electrode is formed across the entire pixel region.

According to an aspect of the invention, the organic layer comprises a column spacer which protrudes to the first insulating substrate.

According to an aspect of the invention, the column spacers which are provided in neighboring pixel regions are connected with each other.

According to an aspect of the invention, the column spacers are formed to correspond to the thin film transistor.

According to an aspect of the invention, the pixel region comprises a plurality of sub pixel regions which are surrounded by the pixel electrode and the exposed common electrode, and each of the sub pixel regions is elongated.

According to an aspect of the invention, an extension direction of the sub pixel regions is different from an extension direction of the gate line.

According to an aspect of the invention, the liquid crystal display device further comprises a first alignment layer which is formed on the pixel electrode and rubbed in a first direction, and a second alignment layer which is formed on the organic layer and rubbed in a second direction, wherein the first direction and the second direction are substantially anti parallel each other.

According to an aspect of the invention, the liquid crystal has a positive dielectric anisotropy, and the angle between the extension direction of the sub pixel regions and the first and second directions is 0° to 45° or 135° to 180°.

According to an aspect of the invention, the first direction and the second direction are substantially in parallel with the extension direction of the gate line.

According to an aspect of the invention, the liquid crystal has a negative dielectric anisotropy, and the angle between the extension direction of the sub pixel regions and the first and second directions is 45° to 90° or 90° to 135°.

According to an aspect of the invention, the first and second directions are substantially in parallel with the extension direction of the gate line.

The foregoing and/or other aspects of the present invention can be achieved by providing a liquid crystal display device, comprising: a first insulating substrate, a gate line and a data line formed on the first insulating layer insulatedly crossing each other to define a pixel region; a thin film transistor which is electrically connected with the gate line and the data line; a pixel electrode which is electrically connected with the thin film transistor, and comprises a stem electrode and a plurality of branch electrodes connected with the stem electrode and substantially in parallel with each other; a second insulating substrate; a common electrode formed on the second insulating substrate; an organic layer formed on the common electrode; a liquid crystal layer interposed between the first insulating substrate and the second insulating substrate, the organic layer comprising a first domain and a second domain, the first domain having a first height and corresponding to the height of at least one of the thin film transistor, the data line and the gate line, and the second domain having a second height lower than the first height and an opening exposing the common electrode in parallel with the branch electrodes.

According to an aspect of the invention, the interval between the branch electrodes is larger than the width of the branch electrodes.

According to an aspect of the invention, the common electrode is formed across the entire pixel region.

According to an aspect of the invention, the first domain and the second domain are connected with each other.

According to an aspect of the invention, the organic layer further comprises a third domain which has a third height less than the first height and connecting the first domains provided in the neighboring pixel regions.

The foregoing and/or other aspects of the present invention can be achieved by providing a method of manufacturing a liquid crystal display device, comprising: providing a first substrate which comprises a first insulating substrate, a gate line and a data line formed on the first insulating substrate and insulatedly crossing each other to define a pixel region, a stem electrode being in parallel with the data line, and a plurality of branch electrodes connected with the stem electrode and substantially in parallel with each other, forming a common electrode on a second insulating substrate; providing a second substrate by forming a photosensitive layer on the common electrode and then exposing and developing the photosensitive layer to form an organic layer which has a first domain having a first height and a second domain which has a second height lower than the first height and exposes the common electrode in parallel with the branch electrodes; and forming a liquid crystal layer between the first substrate and the second substrate.

According to an aspect of the invention, a mask which is used to expose the photosensitive layer comprises a slit pattern corresponding to the second domain.

According to an aspect of the invention, the mask which is used to expose the photosensitive layer comprises a semi-transmission pattern corresponding to the second domain.

According to an aspect of the invention, the first substrate further comprises a thin film transistor which is electrically connected with the gate line and the data line, and the first domain of the second substrate is formed to correspond to the thin film transistor.

According to an aspect of the invention, the organic layer further comprises a third domain which has a third height lower than the first height and connects the first domains provided in the neighboring pixel regions.

According to an aspect of the invention, the first domain and the second domain are connected with each other.

### BRIEF DESCRIPTION OF THE DRAWINGS

The above and/or other aspects of the present invention will become apparent and more readily appreciated from the following description of the exemplary embodiments, taken in conjunction with the accompany drawings, in which:

FIG. 1 illustrates a first substrate of a liquid crystal display device according to a first exemplary embodiment of the present invention;

FIG. 2 illustrates a second substrate of the liquid crystal display device according to the first exemplary embodiment of the present invention;

FIG. 3 is a sectional view of the first substrate of the liquid crystal display device, taken along line III-III in FIG. 1;

FIG. 4 illustrates an arrangement relation between a pixel electrode and a common electrode of the liquid crystal display device according to the first exemplary embodiment of the present invention;

FIG. 5 illustrates an arrangement of a sub pixel region in the liquid crystal display device according to the first exemplary embodiment of the present invention;

FIGS. 6a and 6b illustrate an arrangement of a liquid crystal molecule of the liquid crystal display device according to the first exemplary embodiment of the present invention;

FIGS. 7a to 7d illustrate a manufacturing method of the liquid crystal display device according to the first exemplary embodiment of the present invention;

FIG. 8 illustrates another manufacturing method of the liquid crystal display device according to the first exemplary embodiment of the present invention;

FIG. 9 illustrates a second substrate of a liquid crystal display device according to a second exemplary embodiment of the present invention;

FIG. 10 is a sectional view of the second substrate of the liquid crystal display device, taken along line X-X in FIG. 9;

FIG. 11 illustrates a second substrate of a liquid crystal display device according to a third exemplary embodiment of the present invention;

FIG. 12 is a sectional view of the second substrate of the liquid crystal display device, taken along line XII-XII in FIG. 11;

FIG. 13 illustrates an arrangement of a sub pixel region of a liquid crystal display device according to a fourth exemplary embodiment of the present invention; and

FIGS. 14a and 14b illustrate an arrangement of a liquid crystal molecule of the liquid crystal display device according to the fourth exemplary embodiment of the present invention.

### DETAILED DESCRIPTION OF EXEMPLARY EMBODIMENTS

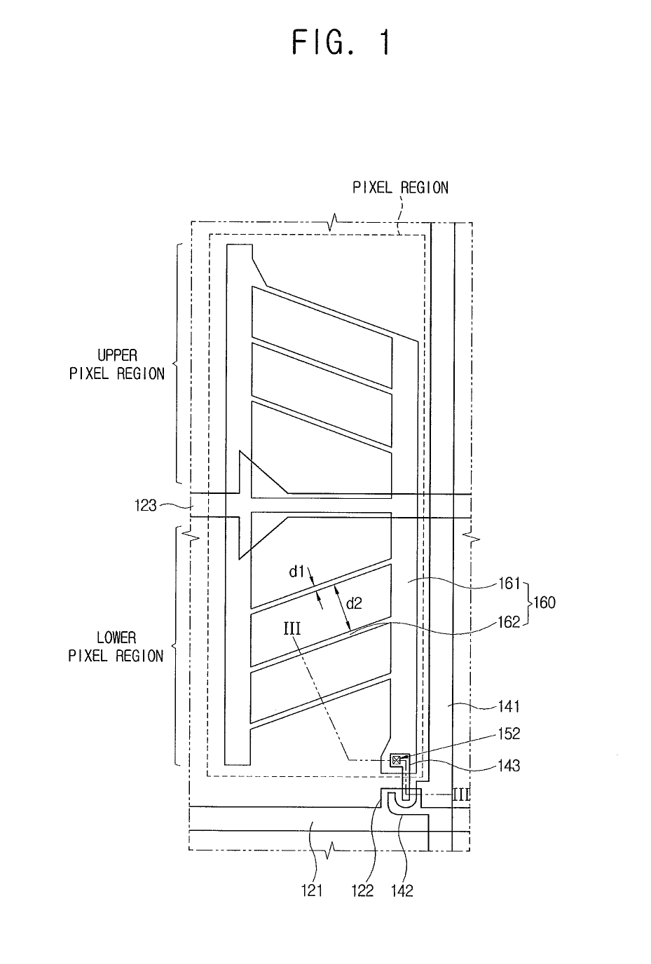

A liquid crystal display device according to a first exemplary embodiment of the present invention will be described with reference to FIGS. 1 to 6.

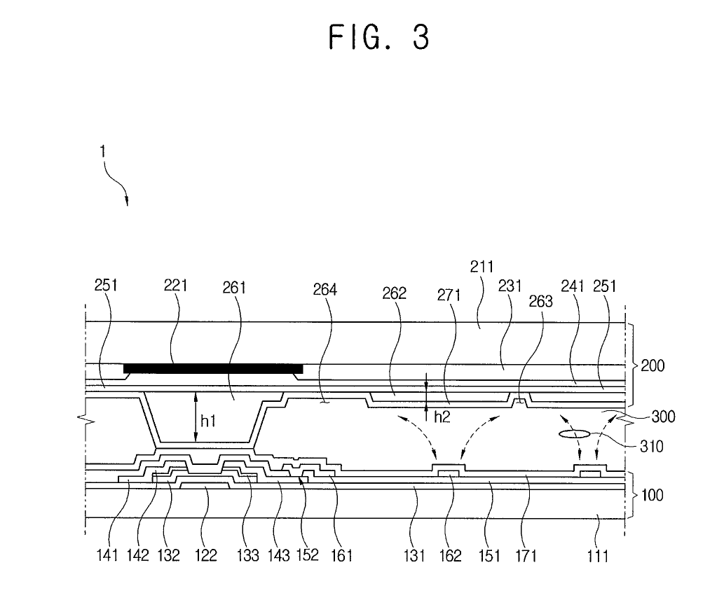

As shown in FIG. 3, a liquid crystal display device 1 includes a first substrate 100 and a second substrate 200 which face each other, and a liquid crystal layer 300 which is disposed between the first and second substrates 100 and 200. In the first exemplary embodiment, a liquid crystal molecule 310 of the liquid crystal layer 300 has a positive dielectric anisotropy. Thus, if an electric field is formed, a longer axis of the liquid crystal molecule 310 is arranged in parallel with the electric field.

Hereinafter, the first substrate 100 will be described with reference to FIGS. 1 and 3.

Gate wires 121, 122 and 123 are formed on a first insulating substrate 111. The gate wires 121, 122 and 123 may include a metal single or multiple layers. The gate wires 121, 122 and 123 include a gate line 121 which extends transversely, a gate electrode 122 which is connected with the gate line 121 and a storage electrode line 123 which extends in parallel with the gate line 121. The storage electrode line 123 forms a storage capacitor by overlapping a pixel electrode 160.

A gate insulating layer 131 including silicon nitride (SiNx) covers the gate wires 121, 122 and 123 on the first insulating substrate 111.

A semiconductor layer 132 including amorphous silicon is formed on the gate insulating layer 131 of the gate electrode 122. An ohmic contact layer 133 including silicide or n+ hydrogenated amorphous silicon highly doped with an n-type dopant is formed on the semiconductor layer 132. The ohmic contact layer 133 is divided into two parts.

Data wires 141, 142 and 143 are formed on the ohmic contact layer 133 and the gate insulating layer 131. The data wires 141, 142 and 143 may also include a metal single or multiple layers. The data wires 141, 142 and 143 include a data line 141 which is formed vertically and crosses the gate line 121, a source electrode 142 which is branched from the data line 141 partly and extends to an upper part of the ohmic contact layer 133 and a drain electrode 143 which is separated from the source electrode 142 and partly formed on the ohmic contact layer 133.

A pixel region is surrounded by the gate line 121 and the data line 141, and has a rectangular shape. The pixel region is divided into an upper pixel region and a lower pixel region by the storage electrode line 123.

A passivation layer 151 comprising silicon nitride, a-Si:C:O or a-Si:O:F deposited by a plasma-enhanced chemical vapor deposition (PECVD) method or an acrylic organic insulating material formed by a coating method is formed on the data wires 141, 142 and 143 and the semiconductor layer 132 that is not covered by the data wires 141, 142 and 143. A contact hole 152 is formed on the passivation layer 151 to expose the drain electrode 143 therethrough.

The pixel electrode 160 is formed on the passivation layer 151. The pixel electrode 160 typically includes a transparent conductive material such as indium tin oxide (ITO), indium zinc oxide (IZO), etc.

The pixel electrode 160 includes a pair of stem electrodes 161 which are formed in parallel with the extension direction of the data line 141, and a branch electrode 162 which is elongated and connects the pair of stem electrodes 161. The branch electrode 162 is elongated not to be in parallel with the gate line 121. The branch electrode 162 is almost axi-symmetric with an axis corresponding to the storage electrode line 123.

The width d1 of the branch electrode 162 is narrower than the interval d2 between the branch electrodes 162.

The pixel electrode 160 is electrically connected with the drain electrode 143 through the contact hole 152. A first alignment layer 171 is formed on the pixel electrode 160.

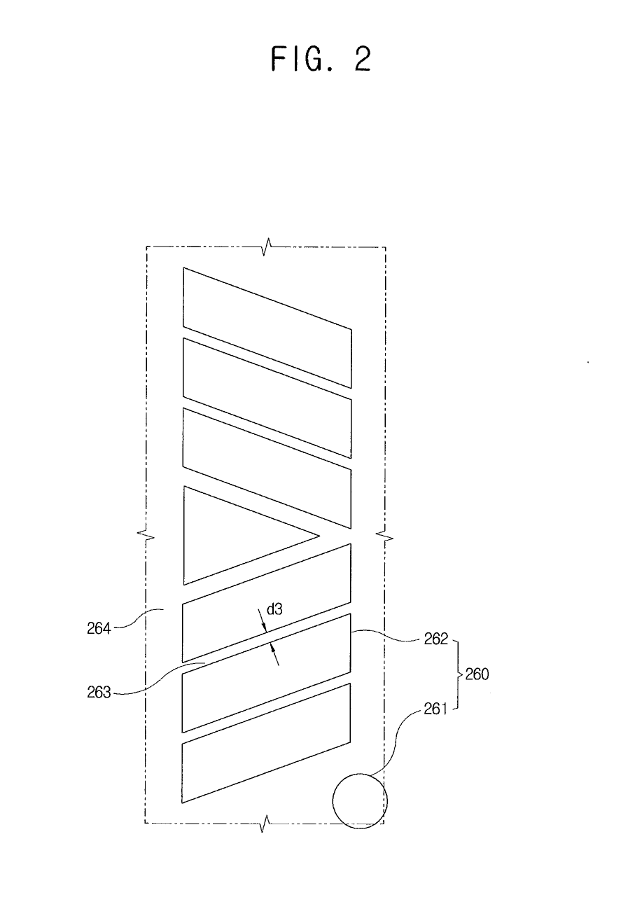

Hereinafter, the second substrate 200 will be described with reference to FIGS. 2 and 3.

A black matrix 221 is formed on a second insulating substrate 211. The black matrix 221 blocks light from being directly emitted to the semiconductor layer 132 of the first substrate 100. The black matrix 221 typically includes a photosensitive organic material added with a black pigment. The black pigment may include carbon black or titanium oxide.

A color filter 231 is formed between the black matrixes 221. The color filter 231 includes three sub layers (not shown) which respectively have red, green and blue colors. The color filter 231 assigns color to light which is emitted from a backlight unit (not shown) and passes through the liquid crystal layer 300. The color filter 231 typically includes a photosensitive organic material.

An overcoat layer 241 is formed on the color filter 231 and the black matrixes 221. The overcoat layer 241 includes an organic material and provides planar surface. The overcoat layer 241 may be omitted.

A common electrode 251 is formed on the overcoat layer 241. The common electrode 251 includes a transparent conductive material such as indium tin oxide (ITO), indium zinc oxide (IZO), etc. The common electrode 251 supplies a voltage to the liquid crystal layer 300, together with the pixel electrode 160 of the first substrate 100. The common electrode 251 is formed across the pixel region and is not patterned.

An organic layer 260 is formed on the common electrode 251. The organic layer 260 includes a first domain 261 corresponding to a thin film transistor T and a second domain 262 which is formed on the pixel region.

The first domain 261 is shaped like an island, and the second domain 262 is divided into a plurality of portions. A first opening 263 is formed between the second domains 262. A second opening 264 is formed around the second domains 262. The openings 263 and 264 expose the common electrode 251.

The height h1 of the first domain 261 is greater than the height h2 of the second domain 262. An end of the first domain 261 may contact the first substrate 100. The first domain 261 is called a column spacer, and maintains a cell gap between the first substrate 100 and the second substrate 200.

The first opening 263 is formed in parallel with the branch electrodes 161, and intersects a center portion of the neighboring branch electrodes 161. Overall, the width d3 of the first opening 263 is uniform.

A second alignment layer 271 is formed on the organic layer 260 and the common electrode 251 that is not covered by the organic layer 260.

The first alignment layer 171 and the second alignment layer 271 are rubbed in a direction in parallel with the gate line 121.

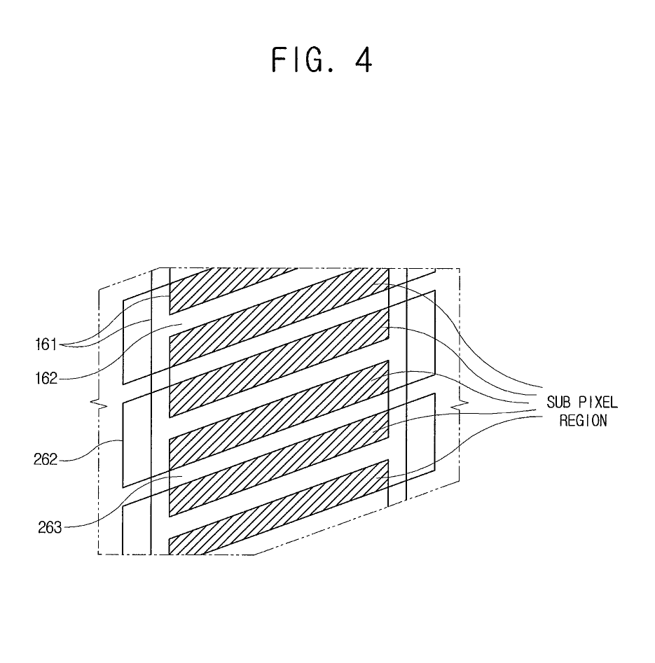

The relation between the pixel electrode 160 and the common electrode 251 that is exposed through the first opening 263 will be described with reference to FIG. 4. FIG. 4 illustrates a part of the lower pixel region.

As shown therein, the pixel region is divided into a plurality of sub pixel regions which is surrounded by the pixel electrode 160 and the common electrode 251 exposed through the first opening 263. The size of the respective sub pixel regions is substantially equivalent. The sub pixel regions are shaped like a parallelogram which is elongated.

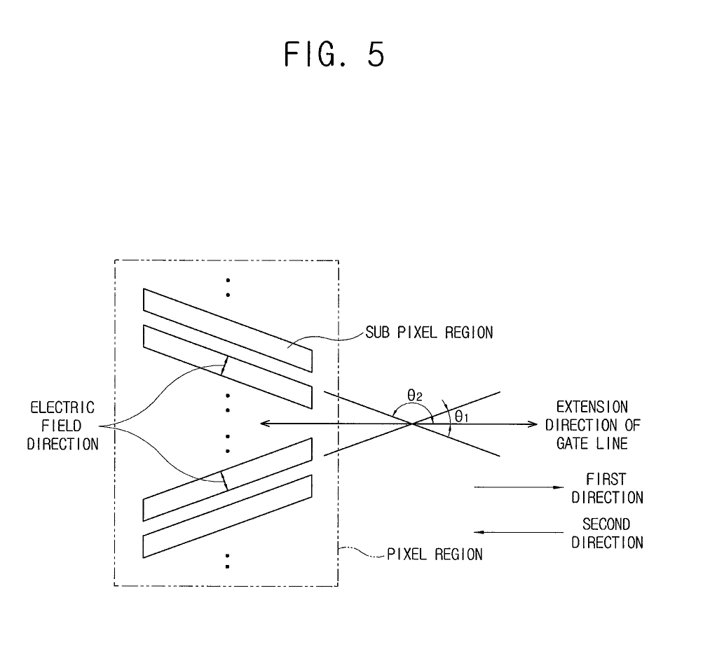

As shown in FIG. 5, the upper pixel regions and the lower pixel regions extend in different directions.

The angle of inclination θ1 between an extension direction of the sub pixel regions and an extension direction of the gate line 121 in the lower pixel region is 0° to 45°. The angle of inclination θ2 between the extension direction of the sub pixel regions and the extension direction of the gate line 121 in the upper pixel region is 135° to 180°.

The combined angle of inclination θ1 and θ2 of the lower and upper pixel regions may be 180°.

While a voltage is not supplied, the liquid crystal molecule 310 of the liquid crystal layer 300 is aligned almost in parallel with the insulating substrates 111 and 211. The longer axis of the liquid crystal molecule 310 is arranged substantially in parallel with a rubbing direction. The first alignment layer 171 is rubbed in a first direction in parallel with the gate line 121 while the second alignment layer 271 is rubbed in a second direction in parallel with the first direction and opposite thereto.

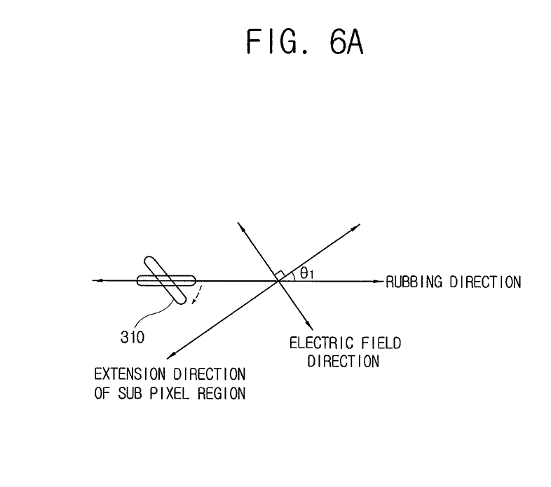

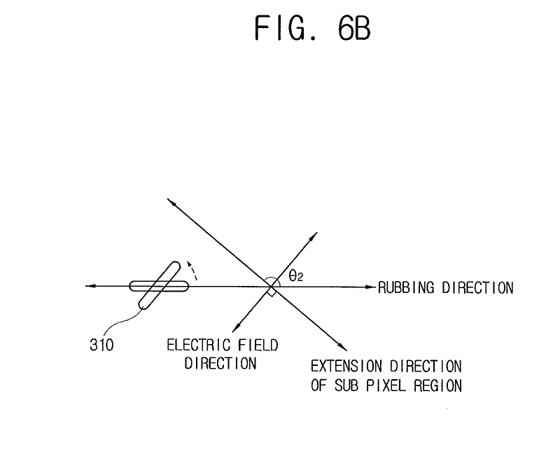

The arrangement of the liquid crystal molecule 310 when the voltage is applied to form an electric field will be described with reference to FIGS. 3, 6a and 6b. FIGS. 6a and 6b illustrate the arrangement of the liquid crystal molecule 310 which is seen from above. FIG. 6a illustrates the lower pixel region while FIG. 6b illustrates the upper pixel region.

When the voltage is applied, the electric field is formed between the pixel electrode 160 and the exposed common electrode 251 as shown in FIG. 3. Particularly, the electric field is formed between the branch electrodes 161 of the pixel electrode 160 and the common electrode 251 exposed by the first opening 263, which face each other.

The pixel electrode 160 and the common electrode 251 are vertically spaced from each other, leaving the liquid crystal layer 300 therebetween. Thus, both a horizontal electric field and a vertical electric field are formed. As the electric field in the horizontal direction is stronger, the liquid crystal molecule 310 mainly rotates in a surface in parallel with the insulating substrates 111 and 211 to adjust a light transmissivity.

The electric field in the horizontal direction is formed in perpendicular to the extension direction of the sub pixel regions as shown in FIGS. 6a and 6b. The liquid crystal molecule 310 is arranged so that the longer axis thereof is in parallel with the electric field.

As shown in FIGS. 6a and 6b, the angles of inclination θ1 and θ2 of the upper pixel regions and the lower pixel regions are different from each other. Thus, the liquid crystal molecule 310 rotates in different directions in the upper pixel regions and the lower pixel regions, and forms two domains. Visibility is improved by dividing each pixel region into two domains.

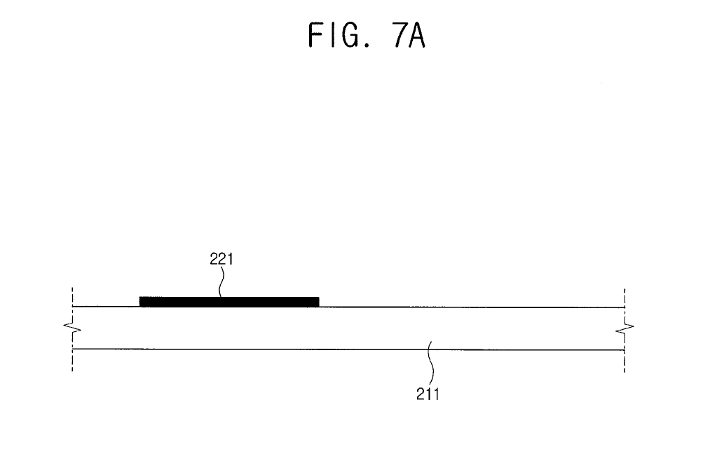

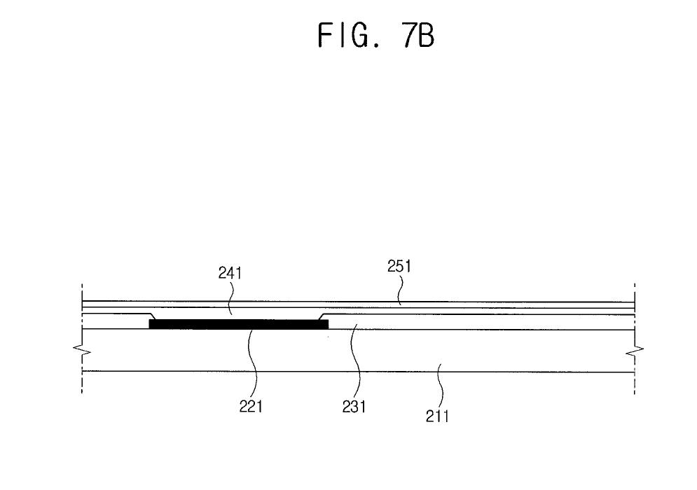

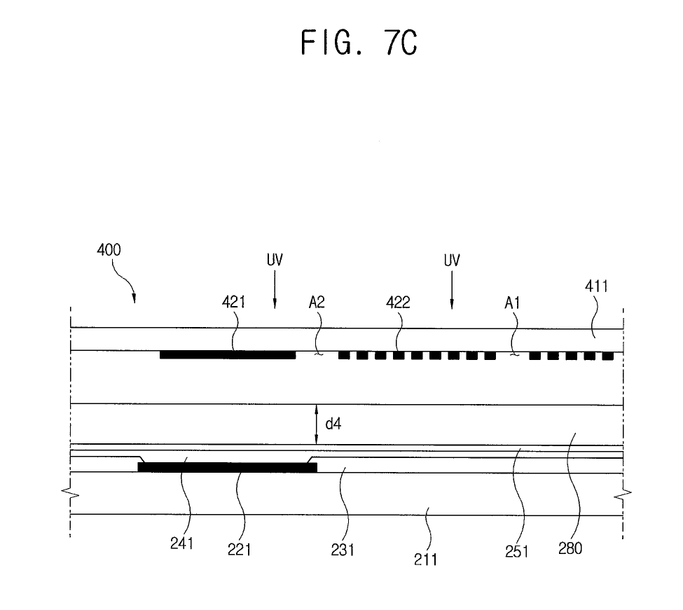

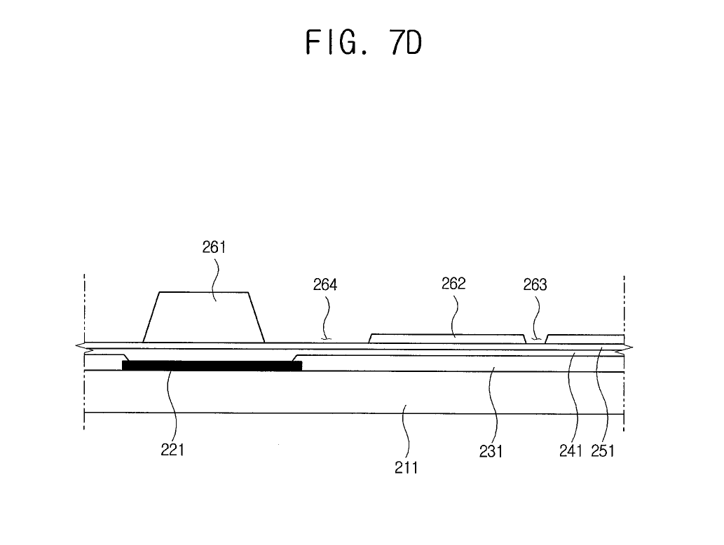

A manufacturing method of the liquid crystal display device 1 according to the first exemplary embodiment of the present invention will be described with reference to FIGS. 7a to 7d.

As shown in FIG. 7a, the black matrixes 221 are formed on the second insulating layer 211. The black matrixes 221 are formed as follows. A photosensitive organic material is added with a black pigment to form a black matrix photosensitive fluid. The black pigment may include carbon black or titanium oxide. The black matrix photosensitive fluid is coated to the second insulating layer 211 and then exposed, developed and baked to complete the black matrixes 221.

As shown in FIG. 7b, the color filter 231 is formed between the black matrixes 221. Then, the overcoat layer 241 and the common electrode 251 are formed on the color filter 231. Color filter compositions having different colors are coated, exposed, developed and baked to complete the color filter 231. The common electrode 251 may be provided by depositing a transparent conductive material such as indium tin oxide (ITO) or indium zinc oxide (IZO) by a sputtering method. The common electrode 251 is not patterned.

As shown in FIG. 7c, a photosensitive layer 280 is formed on the common electrode 251 and is exposed. The photosensitive layer 280 may be provided by a spin coating, nozzle coating or screen coating. A thickness d4 of the photosensitive layer 280 is larger than the height h1 of the first domain 261 in consideration of a decline in the thickness during the developing process.

A mask 400 which is used to expose the photosensitive layer 280 includes a mask substrate 411 and light blocking patterns 421 and 422. The mask substrate 411 may include quartz and the light blocking patterns 421 and 422 may include a chrome layer. The light blocking patterns 421 and 422 will be described hereinafter.

The light blocking pattern 421 corresponding to the first domain 261 is provided to block light 100 percent substantially. The light blocking pattern 422 corresponding to the second domain 262 is formed as a slit. The mask 400 corresponding to parts A1 and A2 on which the first opening 263 and the second opening 264 are formed does not include the light blocking patterns 421 and 422.

FIG. 7d illustrates the organic layer 260 which is completed after the photosensitive layer 280 is exposed and developed. The organic layer 260 includes the first domain 261 which is relatively high and corresponding to the light blocking pattern 421, and the second domain 262 which is relatively low and corresponding to the light blocking pattern 422.

Then, the second alignment layer 271 is formed to complete the second substrate 200.

The first substrate 100 may be manufactured by a known method, and the description thereof will be avoided here.

A sealant is coated along the completed second substrate 200 and the liquid crystal layer 300 is formed by a dropping method. Then, the first and second substrates 100 and 200 are coupled to each other, and the sealant is cured. The first domain 261 of the second substrate 200 corresponds to the thin film transistor T of the first substrate 100. Alternatively, the liquid crystal layer 300 may be formed by a filling method.

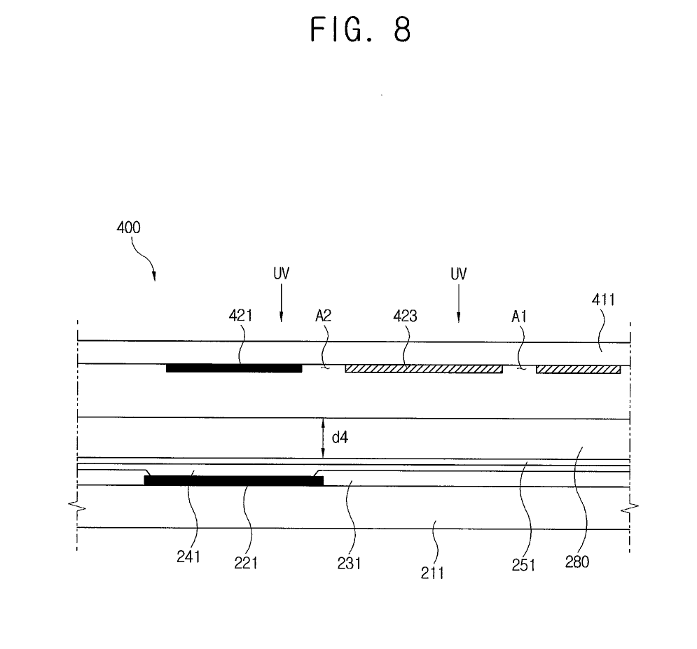

Another manufacturing method of the liquid crystal display device 1 according to the first exemplary embodiment of the present invention will be described with reference to FIG. 8. FIG. 8 illustrates the manufacturing step corresponding that in FIG. 7C.

A semi-transmission layer 423 is formed in the mask 400 corresponding to the second domain 262 of the photosensitive layer 280. The semi-transmission layer 423 may include MoSi.

In the foregoing manufacturing method, a part of the photosensitive layer 280 which exposed to ultraviolet rays is removed. If the photosensitive layer 280 which the ultraviolet rays-exposed port is remained is used, a different light blocking pattern may be provided.

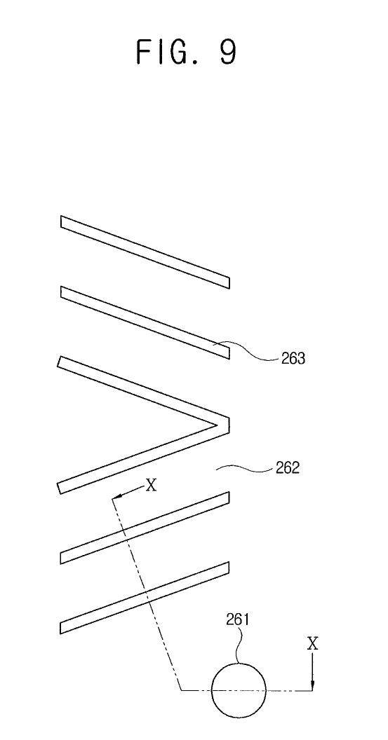

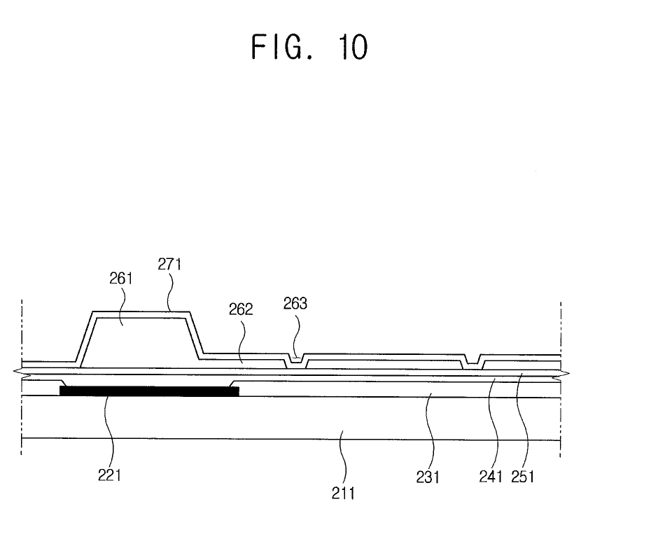

A liquid crystal display device according to a second exemplary embodiment of the present invention will be described with reference to FIGS. 9 and 10.

In the second exemplary embodiment, a first domain 261 and a second domain 262 of an organic layer 260 are connected with each other. Also, the organic layers 260 in neighboring pixel regions are connected with each other.

According to the second exemplary embodiment, the first domain 261 becomes stronger by the second domain 262 surrounding the first domain 261, thereby stably maintaining a cell gap.

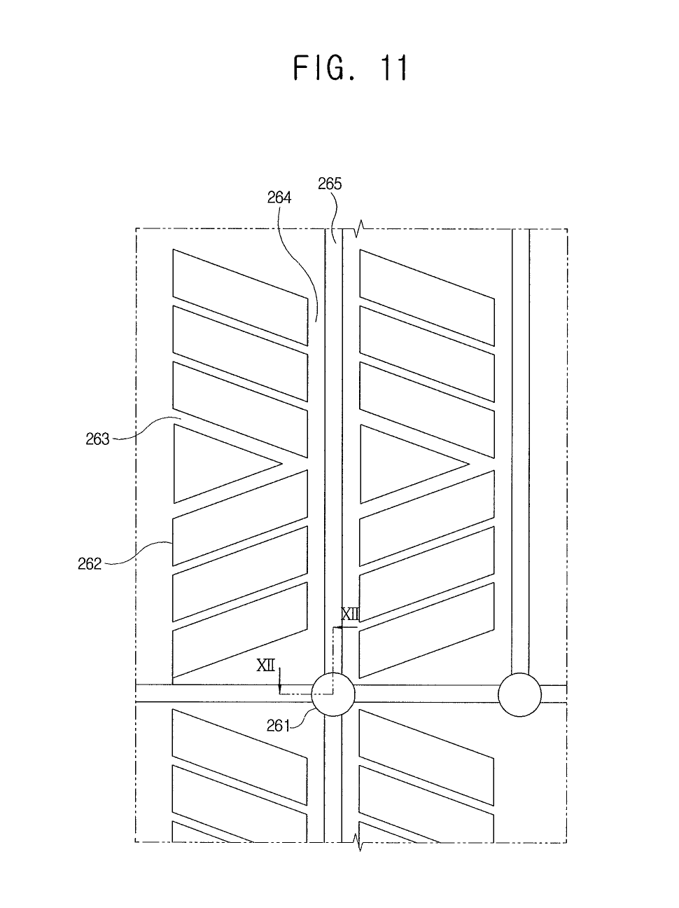

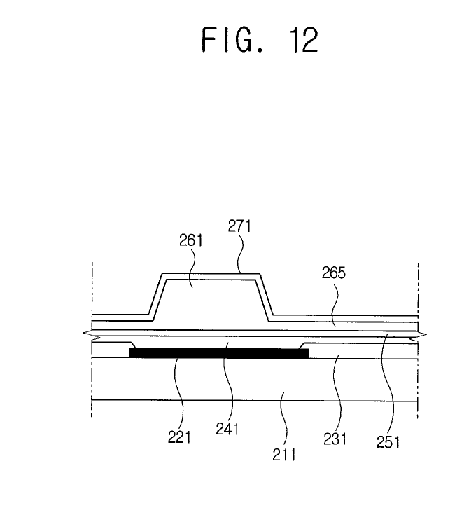

A liquid crystal display device according to a third exemplary embodiment of the present invention will be described with reference to FIGS. 11 and 12.

In the third exemplary embodiment, an organic layer 260 includes a third domain 265 which connects neighboring first domains 261. A height of the third domain 265 is lower than a first domain 261, and may be equivalent to that of second domain 262.

In the third exemplary embodiment, the third domain 265 connecting the first domains 261 makes the first domains 261 stronger. Thus, the strength of the first domains 261 increases to stably maintain a cell gap.

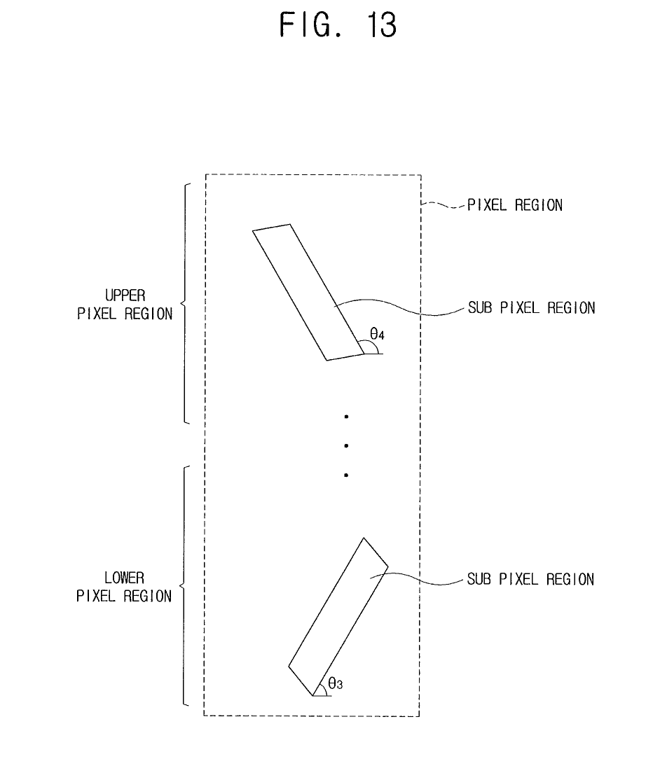

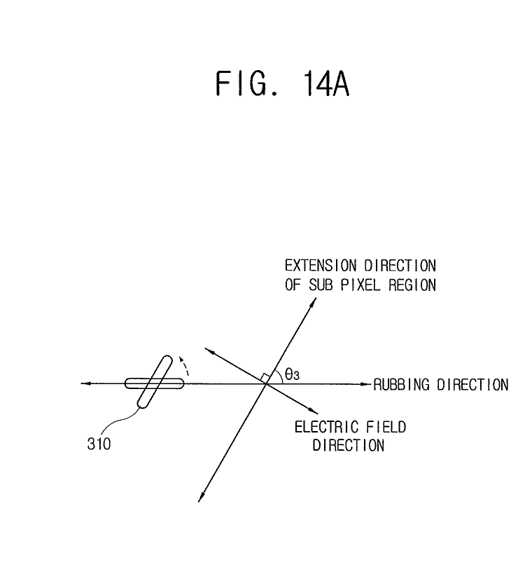

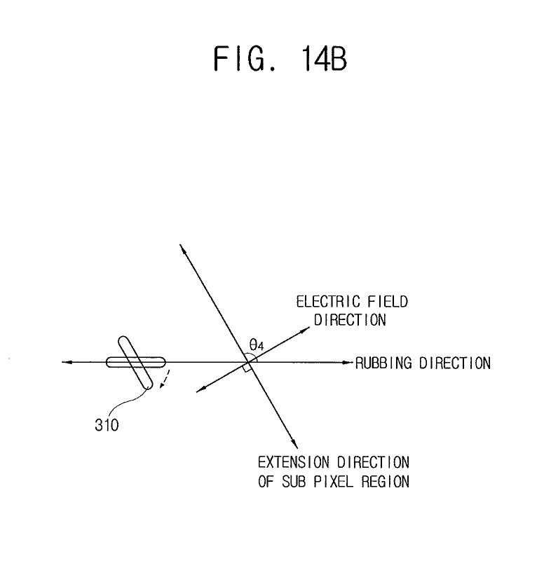

In the foregoing exemplary embodiments, the liquid crystal molecule 310 of the liquid crystal layer 300 has a positive dielectric anisotropy. Otherwise, the liquid crystal molecule 310 of the liquid crystal layer 300 may have a negative dielectric anisotropy, which will be described with reference to FIGS. 13, 14a and 14b. FIGS. 14a and 14b illustrate an arrangement of the liquid crystal molecule 310 seen from above.

As shown in FIG. 13, the pixel region includes the plurality of sub pixel regions. The sub pixel regions include the upper pixel regions and the lower pixel regions which are symmetrical.

The angle of inclination θ3 between the extension direction of the sub pixel regions and the gate line 121 is 45° to 90° in the lower pixel regions. The angle of inclination θ4 between the extension direction of the sub pixel regions and the gate line 121 may be 90° to 135° in the upper pixel regions. The combined angles of inclination θ3 and θ4 may be 180° in the lower and upper pixel regions.

As shown in FIGS. 14a and 14b, when the voltage is supplied to form the electric field, the electric field in the horizontal direction is perpendicular to the extension direction of the sub pixel regions, and the shorter axis of the liquid crystal molecule 310 is arranged in parallel with the electric field. FIG. 14a illustrates the lower pixel regions while FIG. 14b illustrates the upper pixel regions.

The angles of inclination θ3 and θ4 of the upper and lower pixel regions are different from each other. Thus, the liquid crystal molecule 310 rotates in different directions in the upper pixel regions and the lower pixel regions, and forms two domains. The visibility is improved by dividing each pixel region into two domains.

As described above, the present invention provides a liquid crystal display device which simplifies a manufacturing method, and a manufacturing method of the same.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A liquid crystal display device, comprising:
a first insulating substrate,
a gate line and a data line formed on the first insulating layer and insulatedly cross each other to define a pixel region;
a thin film transistor electrically connected with the gate line and the data line;
a pixel electrode electrically connected with the thin film transistor, and comprises a stem electrode and a plurality of branch electrodes connected with the stem electrode and in parallel with each other;
a second insulating substrate;
a common electrode formed on the second insulating substrate;
an organic layer formed on the common electrode and having an opening exposing the common electrode in parallel with the branch electrodes; and
a liquid crystal layer interposed between the first insulating substrate and the second insulating substrate.

2. The liquid crystal display device according to claim 1, wherein the interval between the branch electrodes is larger than the width of the branch electrodes.

3. The liquid crystal display device according to claim 1, wherein the common electrode is formed across the entire pixel region.

4. The liquid crystal display device according to claim 1, wherein the organic layer comprises a column spacer which protrudes to the first insulating substrate.

5. The liquid crystal display device according to claim 4, wherein the column spacers which are provided in neighboring pixel regions are connected with each other.

6. The liquid crystal display device according to claim 4, wherein the column spacers are formed to correspond to the thin film transistor.

7. The liquid crystal display device according to claim 1, wherein the pixel region comprises a plurality of sub pixel regions which are surrounded by the pixel electrode and the exposed common electrode, and each of the sub pixel regions is elongated.

8. The liquid crystal display device according to claim 7, wherein an extension direction of the sub pixel regions is different from an extension direction of the gate line.

9. The liquid crystal display device according to claim 7, further comprising
a first alignment layer formed on the pixel electrode and rubbed in a first direction, and
a second alignment layer formed on the organic layer and rubbed in a second direction, wherein the first direction and the second direction are substantially anti parallel with each other.

10. The liquid crystal display device according to claim 9, wherein the liquid crystal has a positive dielectric anisotropy, and the angle between the extension direction of the sub pixel regions and the first and second directions is 0° to 45° or 135° to 180°.

11. The liquid crystal display device according to claim 10, wherein the first direction and the second direction are substantially in parallel with the extension direction of the gate line.

12. The liquid crystal display device according to claim 9, wherein the liquid crystal has a negative dielectric anisotropy, and an angle between the extension direction of the sub pixel regions and the first and second directions is 45° to 90° or 90° to 135°.

13. The liquid crystal display device according to claim 12, wherein the first and second directions are substantially in parallel with the extension direction of the gate line.

14. A liquid crystal display device, comprising:
a first insulating substrate,
a gate line and a data line formed on the first insulating layer insulatedly crossing each other to define a pixel region;
a thin film transistor which is electrically connected with the gate line and the data line;
a pixel electrode electrically connected with the thin film transistor, and comprises a stem electrode and a plurality of branch electrodes connected with the stem electrode and substantially in parallel with each other;
a second insulating substrate;
a common electrode formed on the second insulating substrate;
an organic layer formed on the common electrode;
a liquid crystal layer interposed between the first insulating substrate and the second insulating substrate,
the organic layer comprising a first domain and a second domain, the first domain having a first height and corresponding to the height of at least one of the thin film transistor, the data line and the gate line, and
the second domain having a second height lower than the first height and an opening exposing the common electrode in parallel with the branch electrodes.

15. The liquid crystal display device according to claim 14, wherein the interval between the branch electrodes is larger than the width of the branch electrodes.

16. The liquid crystal display device according to claim 14, wherein the common electrode is formed across the entire pixel region.

17. The liquid crystal display device according to claim 14, wherein the first domain and the second domain are connected with each other.

18. The liquid crystal display device according to claim 14, wherein the organic layer further comprises a third domain which has a third height lower than the first height and connecting the first domains provided in the neighboring pixel regions.

19. A method of manufacturing a liquid crystal display device, comprising: providing a first substrate which comprises a first insulating substrate, a gate line and a data line formed on the first insulating substrate and insulatedly crossing each other to define a pixel region, a stem electrode being in parallel with the data line, and a plurality of branch electrodes connected with the stem electrode and substantially in parallel with each other,
forming a common electrode on a second insulating substrate; providing a second substrate by forming a photosensitive layer on the common electrode and then exposing and developing the photosensitive layer to form an organic layer which has a first domain having a first height and a second domain which has a second height lower than the first height and exposes the common electrode in parallel with the branch electrodes; and
forming a liquid crystal layer between the first substrate and the second substrate.

20. The method according to claim 19, wherein the mask used to expose the photosensitive layer comprises a slit pattern corresponding to the second domain.

21. The method according to claim 19, wherein the mask used to expose the photosensitive layer comprises a semi-transmission pattern corresponding to the second domain.

22. The method according to claim 19, wherein the first substrate further comprises a thin film transistor electrically connected with the gate line and the data line, and the first domain of the second substrate is formed to correspond to the thin film transistor.

23. The method according to claim 19, wherein the organic layer further height and connects the first domains provided in the neighboring pixel regions.

24. The method according to claim 19, wherein the first domain and the second domain are connected with each other.
